(19) United States
(12) Patent Application Publication
(10) Pub. No.: US 2023/0280867 A1
(43) Pub. Date: Sep. 7, 2023

(54) LASER PROJECTION ON FINGERNAIL

(71) Applicant: Humane, Inc., San Francisco, CA (US)

(72) Inventors: Kenneth Luke Kocienda, Mill Valley, CA (US); Imran A. Chaudhri, San Francisco, CA (US)

(21) Appl. No.: 17/687,542

(22) Filed: Mar. 4, 2022

(51) Int. Cl. G06F 3/042; G06F 3/01; G03B 17/54; G03B 21/60

(52) U.S. Cl. CPC G06F 3/0425; G06F 3/017; G03B 17/54; G03B 21/60; G06F 3/04817

(57) ABSTRACT

Systems, methods, devices and non-transitory, computer-readable storage mediums are disclosed for a wearable multimedia device and cloud computing platform with an application ecosystem for processing multimedia data captured by the wearable multimedia device. In an embodiment, a method comprises: projecting, with a laser projector of a wearable multimedia device, a user interface element onto a surface; determining, based on sensor data obtained from at least one sensor of the wearable multimedia device, that the user interface element is at least partially obscured by an object; detecting, based on the sensor data, a fingernail of a user of the wearable multimedia device; and responsive to detecting that the user interface element is at least partially obscured by the object, and detecting the fingernail of the user of the wearable multimedia device, projecting the user interface element on the fingernail.

### TECHNICAL FIELD

This disclosure relates generally to user interfaces for use with wearable multimedia devices.

### BACKGROUND

High-precision laser scanners (e.g., MEMS scanners) have been developed that can turn any surface into a virtual interface (VI). For example, a laser projected VI can be projected onto the palm of a user's hand or other surface. Three-dimensional (3D) depth sensors (e.g., a time of flight (TOF) camera) can be used to detect user gestures that are interacting with one or more VI elements projected on the surface. In the case of the user's palm, there is very little surface area in which to project a detailed VI. This limited space can limit the number and types of user interactions with the VI, and thus potentially limit the number and types of applications that rely on the VI for input and output.

### SUMMARY

Systems, methods, devices and non-transitory, computer-readable storage mediums are disclosed for laser projections on fingernails.

In an embodiment, a method comprises: projecting, with a laser projector of a wearable multimedia device, a user interface element onto a surface; detecting, based on sensor data obtained from at least one sensor of the wearable multimedia device, that the user interface element is at least partially obscured by an object; detecting, based on the sensor data, a fingernail of a user of the wearable multimedia device; and responsive to the detecting that the user interface element is at least partially obscured by an object, and a fingernail of a user of the wearable multimedia device, projecting the user interface element on the fingernail.

In an embodiment, the surface is the user's palm.

In an embodiment, the sensor data includes depth data captured by at least one of a camera or a depth sensor.

In an embodiment, the method further comprises: detecting, based on the sensor data, a gesture made by a finger that includes the fingernail; and responsive to the gesture, performing at least one action on the wearable multimedia device.

In an embodiment, the user interface element is an icon.

In an embodiment, detecting that the user interface element is at least partially obscured by an object, further comprises: detecting a percentage of overlap of the user interface by the object.

In an embodiment, detecting, based on sensor data obtained from at least one sensor of the wearable multimedia device, that the user interface element is at least partially obscured by an object, further comprises: detecting, based on camera data in a camera reference frame, a user interface element location on the surface; detecting, based on depth data, an object location; projecting at least a portion of the depth data representing the object into a camera reference frame; determining, based on the locations of the user interface element and the object in the camera reference frame, that the user interface element is at least partially obscured by the object.

In an embodiment, a method comprises: projecting, with a laser projector of a wearable multimedia device, a user interface element onto a surface; determining, based on sensor data obtained from at least one sensor of the wearable multimedia device, that the user interface element is associated with one or more other user interface elements; detecting, based on the sensor data, one or more fingernails of a user of the wearable multimedia device; and responsive to determining that the user interface element is associated with one or more other user interface elements, and detection of one or more fingernails of a user of the wearable multimedia device, projecting the one or more other user interface elements on the one or more fingernails.

In an embodiment, determining, based on at least one of camera data or depth data, one or more fingernail locations; and projecting, based on the one or more fingernail locations, the one or more other user interface elements at the one or more fingernail locations.

In an embodiment, a system comprises: at least one processor; and memory storing instructions that, when executed by the at least one processor, cause the at least one processor to perform any of the methods described above.

In an embodiment, a non-transitory computer-readable storage medium configured to store instructions that, when executed by the at least one processor, cause the at least one processor to perform any of the methods described above.

The implementations described herein can provide various technical benefits. For example, one or more of a user's fingernail(s) can provide additional projection surface(s) for user interface element(s) or other elements (e.g., text, numbers, letters). The user's fingernail facilitates interacting with user interface element(s) projected on the user's palm or other surface when those user interface element(s) are obscured by the user's finger or another object. The fingernails can also provide additional projection surfaces to augment other user interface element(s) projected on the user's palm or another surface, such as adding additional icons. The user can also free up the use of a hand by interacting with a user interface element projected on their fingernail using a finger gesture (e.g., bending the finger).

The details of the disclosed embodiments are set forth in the accompanying drawings and the description below. Other features, objects and advantages are apparent from the description, drawings and claims.

### DESCRIPTION OF DRAWINGS

FIG. 1 is a block diagram of an operating environment for a wearable multimedia device and cloud computing platform with an application ecosystem for processing multimedia data captured by the wearable multimedia device, according to an embodiment

FIG. 2 is a block diagram of a data processing system implemented by the cloud computing platform of FIG. 1, according to an embodiment.

FIG. 3 is a block diagram of a data processing pipeline for processing a context data stream, according to an embodiment.

FIG. 4 is a block diagram of another data processing for processing a context data stream for a transportation application, according to an embodiment.

FIG. 5 illustrates data objects used by the data processing system of FIG. 2, according to an embodiment.

FIG. 6 is flow diagram of a data pipeline process, according to an embodiment.

FIG. 7 is an architecture for the cloud computing platform, according to an embodiment.

FIG. 8 is an architecture for the wearable multimedia device, according to an embodiment.

FIG. 9 is a system block diagram of a projector architecture, according to an embodiment.

FIG. 10 illustrates a laser projection area on a user's palm, according to an embodiment.

FIG. 11 illustrates moving a projection of a user interface element on a user's palm to the user's fingernail, according to an embodiment.

FIG. 12 illustrates projecting user interface elements on a user's fingernails to augment a user interface element projected on the user's palm or other surface, according to an embodiment.

FIG. 13 is a flow diagram of a process of moving a projection of a user interface element on a user's palm or other surface to the user's fingernail or other surface, according to an embodiment

FIG. 14 is a flow diagram of a process for projecting user interface elements on a user's fingernails or other surface to augment a user interface element projected on the user's palm or other surface, according to an embodiment.

The same reference symbol used in various drawings indicates like elements.

### DETAILED DESCRIPTION

### Example Wearable Multimedia Device

The features and processes described herein can be implemented on a wearable multimedia device. In an embodiment, the wearable multimedia device is a lightweight, small form factor, battery-powered device that can be attached to a user's clothing or an object using a tension clasp, interlocking pin back, magnet, or any other attachment mechanism. The wearable multimedia device includes a digital image capture device (e.g., a camera with a 180° FOV with optical image stabilizer (OIS)) that allows a user to spontaneously and/or continuously capture multimedia data (e.g., video, audio, depth data, biometric data) of life events (“moments”) and document transactions (e.g., financial transactions) with minimal user interaction or device set-up. The multimedia data (“context data”) captured by the wireless multimedia device is uploaded to a cloud computing platform with an application ecosystem that allows the context data to be processed, edited and formatted by one or more applications (e.g., Artificial Intelligence (AI) applications) into any desired presentation format (e.g., single image, image stream, video clip, audio clip, multimedia presentation, or image gallery) that can be downloaded and replayed on the wearable multimedia device and/or any other playback device. For example, the cloud computing platform can transform video data and audio data into any desired filmmaking style (e.g., documentary, lifestyle, candid, photojournalism, sport, street) specified by the user.

In an embodiment, the context data is processed by server computer(s) of the cloud computing platform based on user preferences. For example, images can be color graded, stabilized and cropped perfectly to the moment the user wants to relive based on the user preferences. The user preferences can be stored in a user profile created by the user through an online account accessible through a website or portal, or the user preferences can be learned by the platform over time (e.g., using machine learning). In an embodiment, the cloud computing platform is a scalable distributed computing environment. For example, the cloud computing platform can be a distributed streaming platform (e.g., Apache Kafka™) with real-time streaming data pipelines and streaming applications that transform or react to streams of data.

In an embodiment, the user can start and stop a context data capture session on the wearable multimedia device with a simple touch gesture (e.g., a tap or swipe), by speaking a command or any other input mechanism. All or portions of the wearable multimedia device can automatically power down when it detects that it is not being worn by the user using one or more sensors (e.g., proximity sensor, optical sensor, accelerometers, gyroscopes).

The context data can be encrypted and compressed and stored in an online database associated with a user account using any desired encryption or compression technology. The context data can be stored for a specified period of time that can be set by the user. The user can be provided through a website, portal or mobile application with opt-in mechanisms and other tools for managing their data and data privacy.

In an embodiment, the context data includes point cloud data to provide three-dimensional (3D) surface mapped objects that can be processed using, for example, augmented reality (AR) and virtual reality (VR) applications in the application ecosystem. The point cloud data can be generated by a depth sensor (e.g., LiDAR or Time of Flight (TOF)) embedded on the wearable multimedia device.

In an embodiment, the wearable multimedia device includes a Global Navigation Satellite System (GNSS) receiver (e.g., Global Positioning System (GPS)) and one or more inertial sensors (e.g., accelerometers, gyroscopes) for determining the location and orientation of the user wearing the device when the context data was captured. In an embodiment, one or more images in the context data can be used by a localization application, such as a visual odometry application, in the application ecosystem to determine the position and orientation of the user.

In an embodiment, the wearable multimedia device can also include one or more environmental sensors, including but not limited to: an ambient light sensor, magnetometer, pressure sensor, voice activity detector, etc. This sensor data can be included in the context data to enrich a content presentation with additional information that can be used to capture the moment.

In an embodiment, the wearable multimedia device can include one or more biometric sensors, such as a heart rate sensor, fingerprint scanner, etc. This sensor data can be included in the context data to document a transaction or to indicate the emotional state of the user during the moment (e.g., elevated heart rate could indicate excitement or fear).

In an embodiment, the wearable multimedia device includes a headphone jack connecting a headset or earbuds, and one or more microphones for receiving voice command and capturing ambient audio. In an alternative embodiment, the wearable multimedia device includes short range communication technology, including but not limited to Bluetooth, IEEE 802.15.4 (ZigBee™) and near field communications (NFC). The short range communication technology can be used to wirelessly connect to a wireless headset or earbuds in addition to, or in place of the headphone jack, and/or can wirelessly connect to any other external device (e.g., a computer, printer, projector, television and other wearable devices).

In an embodiment, the wearable multimedia device includes a wireless transceiver and communication protocol stacks for a variety of communication technologies, including Wi-Fi, 3G, 4G and 5G communication technologies. In an embodiment, the headset or earbuds also include sensors (e.g., biometric sensors, inertial sensors) that provide information about the direction the user is facing, to provide commands with head gestures or playback of spatial audio, etc. In an embodiment, the camera direction can be controlled by the head gestures, such that the camera view follows the user's view direction. In an embodiment, the wearable multimedia device can be embedded in or attached to the user's glasses.

In an embodiment, the wearable multimedia device includes a projector (e.g., a laser projector) or other digital projection technology (e.g., Liquid Crystal on Silicon (LCoS or LCOS), Digital Light Processing (DLP) or Liquid Chrystal Display (LCD) technology), or can be wired or wirelessly coupled to an external projector, that allows the user to replay a moment on a surface such as a wall or table top or on a surface of the user's hand (e.g., the user's palm). In another embodiment, the wearable multimedia device includes an output port that can connect to a projector or other output device.

In an embodiment, the wearable multimedia capture device includes a touch surface responsive to touch gestures (e.g., a tap, multi-tap or swipe gesture). The wearable multimedia device may include a small display for presenting information and one or more light indicators to indicate on/off status, power conditions or any other desired status.

In an embodiment, the cloud computing platform can be driven by context-based gestures (e.g., air gesture) in combination with speech queries, such as the user pointing to an object in their environment and saying: “What is that building?” The cloud computing platform uses the air gesture to narrow the scope of the viewport of the camera and isolate the building. One or more images of the building are captured and optionally cropped (e.g., to protect privacy) and sent to the cloud computing platform where an image recognition application can run an image query and store or return the results to the user. Air and touch gestures can also be performed on a projected ephemeral display, for example, responding to user interface elements projected on a surface.

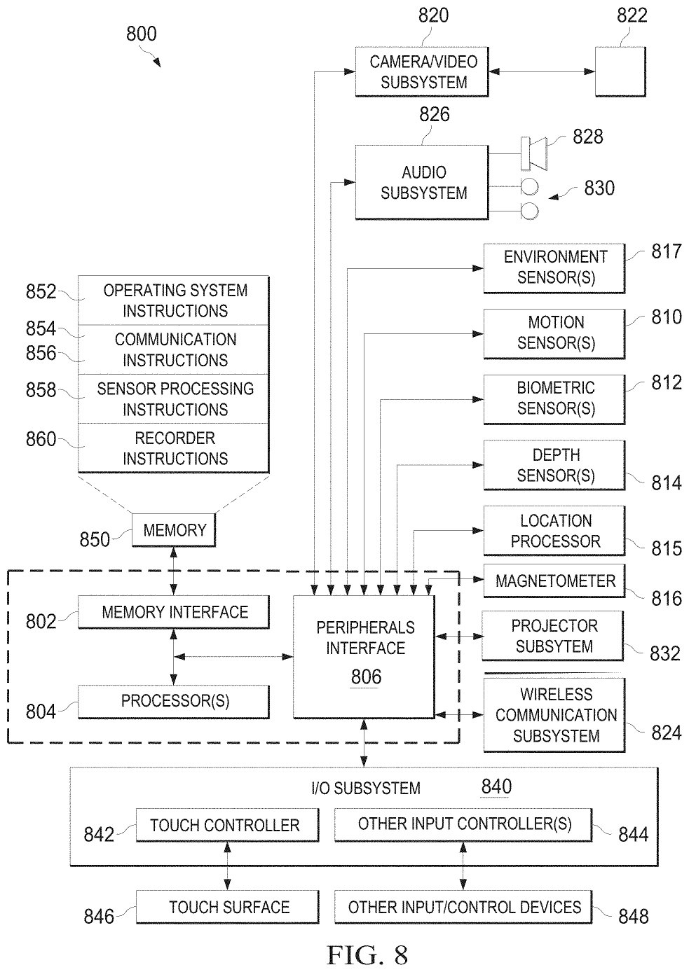

In an embodiment, the context data can be encrypted on the device and on the cloud computing platform so that only the user or any authorized viewer can relive the moment on a connected screen (e.g., smartphone, computer, television, etc.) or as a projection on a surface. An example architecture for the wearable multimedia device is described in reference to FIG. 8.

In addition to personal life events, the wearable multimedia device simplifies the capture of financial transactions that are currently handled by smartphones. The capture of every day transactions (e.g., business transactions, micro transactions) is made simpler, faster and more fluid by using sight assisted contextual awareness provided by the wearable multimedia device. For example, when the user engages in a financial transaction (e.g., making a purchase), the wearable multimedia device will generate data memorializing the financial transaction, including a date, time, amount, digital images or video of the parties, audio (e.g., user commentary describing the transaction) and environment data (e.g., location data). The data can be included in a multimedia data stream sent to the cloud computing platform, where it can be stored online and/or processed by one or more financial applications (e.g., financial management, accounting, budget, tax preparation, inventory, etc.).

In an embodiment, the cloud computing platform provides graphical user interfaces on a website or portal that allow various third party application developers to upload, update and manage their applications in an application ecosystem. Some example applications can include but are not limited to: personal live broadcasting (e.g., Instagram™ Life, Snapchat™), senior monitoring (e.g., to ensure that a loved one has taken their medicine), memory recall (e.g., showing a child's soccer game from last week) and personal guide (e.g., AI enabled personal guide that knows the location of the user and guides the user to perform an action).

In an embodiment, the wearable multimedia device includes one or more microphones and a headset. In some embodiments, the headset wire includes the microphone. In an embodiment, a digital assistant is implemented on the wearable multimedia device that responds to user queries, requests and commands. For example, the wearable multimedia device worn by a parent captures moment context data for a child's soccer game, and in particular a “moment” where the child scores a goal. The user can request (e.g., using a speech command) that the platform create a video clip of the goal and store it in their user account. Without any further actions by the user, the cloud computing platform identifies the correct portion of the moment context data (e.g., using face recognition, visual or audio cues) when the goal is scored, edits the moment context data into a video clip, and stores the video clip in a database associated with the user account.

In an embodiment, the wearable multimedia device can include photovoltaic surface technology to sustain battery life and inductive charging circuitry (e.g., Qi) to allow for inductive charging on charge mats and wireless over-the-air (OTA) charging.

In an embodiment, the wearable multimedia device is configured to magnetically couple or mate with a rechargeable portable battery pack. The portable battery pack includes a mating surface that has permanent magnet (e.g., N pole) disposed thereon, and the wearable multimedia device has a corresponding mating surface that has permanent magnet (e.g., S pole) disposed thereon. Any number of permanent magnets having any desired shape or size can be arranged in any desired pattern on the mating surfaces.

The permanent magnets hold portable battery pack and wearable multimedia device together in a mated configuration with clothing (e.g., a user's shirt) in between. In an embodiment, the portable battery pack and wearable multimedia device have the same mating surface dimensions, such that there is no overhanging portions when in a mated configuration. A user magnetically fastens the wearable multimedia device to their clothing by placing the portable battery pack underneath their clothing and placing the wearable multimedia device on top of portable battery pack outside their clothing, such that permanent magnets attract each other through the clothing.

In an embodiment, the portable battery pack has a built-in wireless power transmitter which is used to wirelessly power the wearable multimedia device while in the mated configuration using the principle of resonant inductive coupling. In an embodiment, the wearable multimedia device includes a built-in wireless power receiver which is used to receive power from the portable battery pack while in the mated configuration.

### System Overview

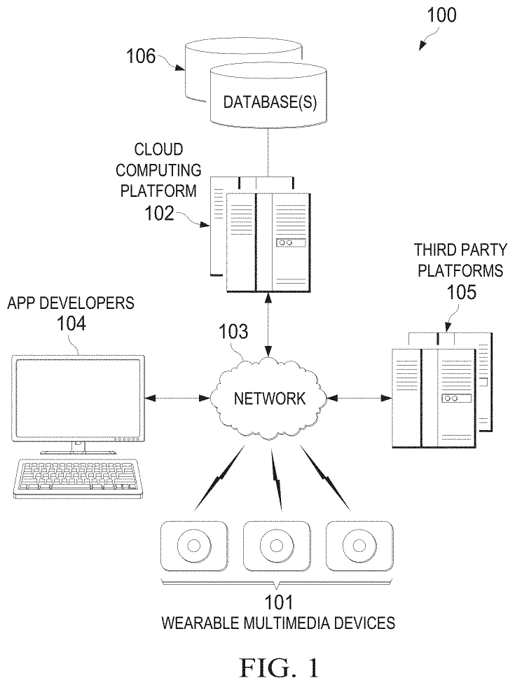

FIG. 1 is a block diagram of an operating environment for a wearable multimedia device and cloud computing platform with an application ecosystem for processing multimedia data captured by the wearable multimedia device, according to an embodiment. Operating environment 100 includes wearable multimedia devices 101, cloud computing platform 102, network 103, application (“app”) developers 104 and third party platforms 105. Cloud computing platform 102 is coupled to one or more databases 106 for storing context data uploaded by wearable multimedia devices 101.

As previously described, wearable multimedia devices 101 are lightweight, small form factor, battery-powered devices that can be attached to a user's clothing or an object using a tension clasp, interlocking pin back, magnet or any other attachment mechanism. Wearable multimedia devices 101 include a digital image capture device (e.g., a camera with a 180° FOV and OIS) that allows a user to spontaneously capture multimedia data (e.g., video, audio, depth data) of “moments” and document every day transactions (e.g., financial transactions) with minimal user interaction or device set-up. The context data captured by wireless multimedia devices 101 are uploaded to cloud computing platform 102. Cloud computing platform 101 includes an application ecosystem that allows the context data to be processed, edited and formatted by one or more server side applications into any desired presentation format (e.g., single image, image stream, video clip, audio clip, multimedia presentation, images gallery) that can be downloaded and replayed on the wearable multimedia device and/or other playback device.

By way of example, at a child's birthday party a parent can clip the wearable multimedia device on their clothing (or attached the device to a necklace or chain and wear around their neck) so that the camera lens is facing in their view direction. The camera includes a 180° FOV that allows the camera to capture almost everything that the user is currently seeing. The user can start recording by simply tapping the surface of the device or pressing a button or speaking a command. No additional set-up is required. A multimedia data stream (e.g., video with audio) is recorded that captures the special moments of the birthday (e.g., blowing out the candles). This “context data” is sent to cloud computing platform 102 in real-time through a wireless network (e.g., Wi-Fi, cellular). In an embodiment, the context data is stored on the wearable multimedia device so that it can be uploaded at a later time. In another embodiment, the user can transfer the context data to another device (e.g., personal computer hard drive, smartphone, tablet computer, thumb drive) and upload the context data to cloud computing platform 102 at a later time using an application.

In an embodiment, the context data is processed by one or more applications of an application ecosystem hosted and managed by cloud computing platform 102. Applications can be accessed through their individual application programming interfaces (APIs). A custom distributed streaming pipeline is created by cloud computing platform 102 to process the context data based on one or more of the data type, data quantity, data quality, user preferences, templates and/or any other information to generate a desired presentation based on user preferences. In an embodiment, machine learning technology can be used to automatically select suitable applications to include in the data processing pipeline with or without user preferences. For example, historical user context data stored in a database (e.g., NoSQL database) can be used to determine user preferences for data processing using any suitable machine learning technology (e.g., deep learning or convolutional neural networks).

In an embodiment, the application ecosystem can include third party platforms 105 that process context data. Secure sessions are set-up between cloud computing platform 102 and third party platforms 105 to send/receive context data. This design allows third party app providers to control access to their application and to provide updates. In other embodiments, the applications are run on servers of cloud computing platform 102 and updates are sent to cloud computing platform 102. In the latter embodiment, app developers 104 can use an API provided by cloud computing platform 102 to upload and update applications to be included in the application ecosystem.

### Example Data Processing System

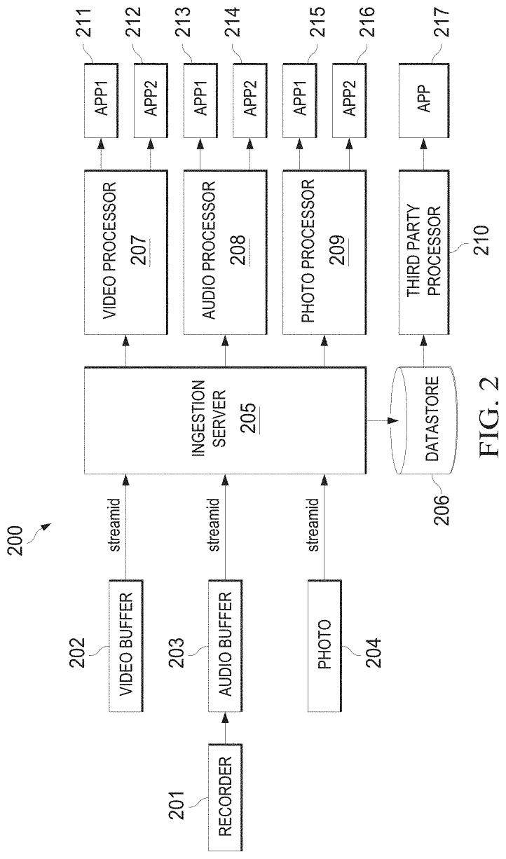

FIG. 2 is a block diagram of a data processing system implemented by the wearable multimedia device and the cloud computing platform of FIG. 1, according to an embodiment. Data processing system 200 includes recorder 201, video buffer 202, audio buffer 203, photo buffer 204, ingestion server 205, data store 206, video processor 207, audio processor 208, photo processor 209 and third party processor 210.

A recorder 201 (e.g., a software application) running on a wearable multimedia device records video, audio and photo data (“context data”) captured by a camera and audio subsystem, and stores the data in buffers 202, 203, 204, respectively. This context data is then sent (e.g., using wireless OTA technology) to ingestion server 205 of cloud computing platform 102. In an embodiment, the data can be sent in separate data streams each with a unique stream identifier (streamid). The streams are discrete pieces of data that may contain the following example attributes: location (e.g., latitude, longitude), user, audio data, video stream of varying duration and N number of photos. A stream can have a duration of 1 to MAXSTREAM_LEN seconds, where in this example MAXSTREAM_LEN=20 seconds.

Ingestion server 205 ingests the streams and creates a stream record in data store 206 to store the results of processors 207-209. In an embodiment, the audio stream is processed first and is used to determine the other streams that are needed. Ingestion server 205 sends the streams to the appropriate processor 207-209 based on streamid. For example, the video stream is sent to video processor 207, the audio stream is sent to audio processor 208 and the photo stream is sent to photo processor 209. In an embodiment, at least a portion of data collected from the wearable multimedia device (e.g., image data) is processed into metadata and encrypted so that it can be further processed by a given application and sent back to the wearable multimedia device or other device.

Processors 207-209 can run proprietary or third party applications as previously described. For example, video processor 207 can be a video processing server that sends raw video data stored in video buffer 202 to a set of one or more image processing/editing applications 211, 212 based on user preferences or other information. Processor 207 sends requests to applications 211, 212, and returns the results to ingestion server 205. In an embodiment, third party processor 210 can process one or more of the streams using its own processor and application 217. In another example, audio processor 208 can be an audio processing server that sends speech data stored in audio buffer 203 to speech-to-text converter applications 213, 214. In another example, photo processor 209 can be an image processing server that sends image data stored in photo buffer 204 to image processing applications 215, 216.

### Example Scene Identification Application

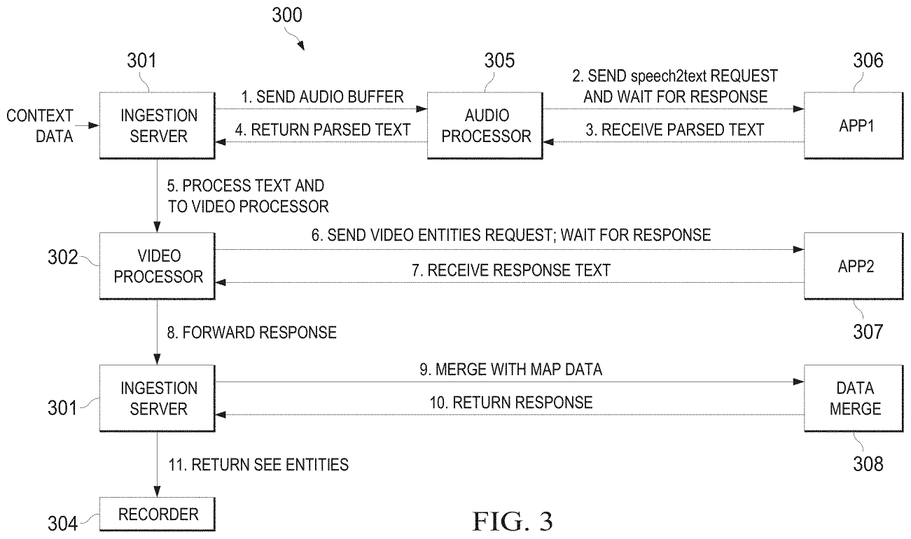

FIG. 3 is a block diagram of a data processing pipeline for processing a context data stream, according to an embodiment. In this embodiment, data processing pipeline 300 is created and configured to determine what the user is seeing based on the context data captured by a wearable multimedia device worn by the user. Ingestion server 301 receives an audio stream (e.g., including user commentary) from audio buffer 203 of wearable multimedia device and sends the audio stream to audio processor 305. Audio processor 305 sends the audio stream to app 306 which performs speech-to-text conversion and returns parsed text to audio processor 305. Audio processor 305 returns the parsed text to ingestion server 301.

Video processor 302 receives the parsed text from ingestion server 301 and sends a requests to video processing app 307. Video processing app 307 identifies objects in the video scene and uses the parsed text to label the objects. Video processing app 307 sends a response describing the scene (e.g., labeled objects) to video processor 302. Video processor then forwards the response to ingestion server 301. Ingestion server 301 sends the response to data merge process 308, which merges the response with the user's location, orientation and map data. Data merge process 308 returns a response with a scene description to recorder 304 on the wearable multimedia device. For example, the response can include text describing the scene as the child's birthday party, including a map location and a description of objects in the scene (e.g., identify people in the scene). Recorder 304 associates the scene description with the multimedia data (e.g., using a streamid) stored on the wearable multimedia device. When the user recalls the data, the data is enriched with the scene description.

In an embodiment, data merge process 308 may use more than just location and map data. There can also be a notion of ontology. For example, the facial features of the user's Dad captured in an image can be recognized by the cloud computing platform, and be returned as “Dad” rather than the user's name, and an address such as “555 Main Street, San Francisco, Calif.” can be returned as “Home.” The ontology can be specific to the user and can grow and learn from the user's input.

### Example Transportation Application

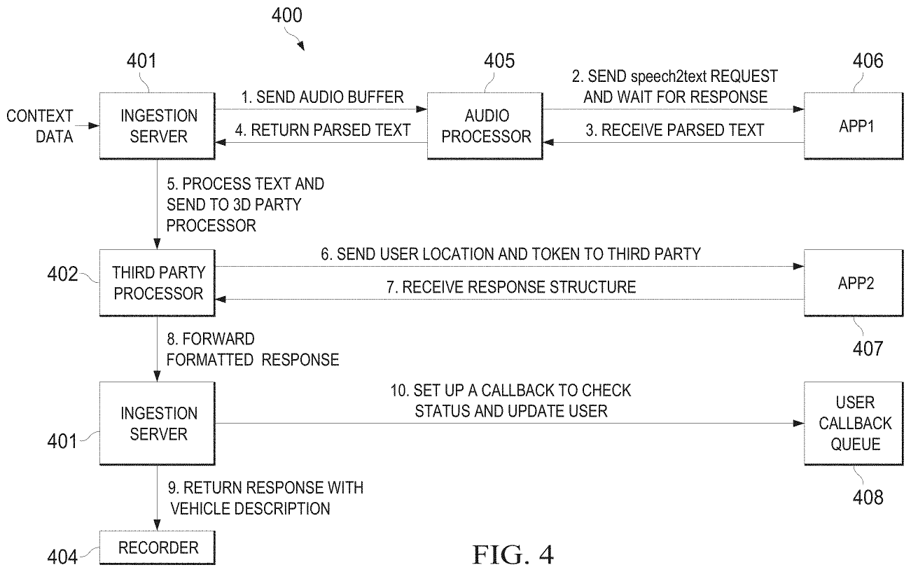

FIG. 4 is a block diagram of another data processing for processing a context data stream for a transportation application, according to an embodiment. In this embodiment, data processing pipeline 400 is created to call a transportation company (e.g., Uber®, Lyft®) to get a ride home. Context data from a wearable multimedia device is received by ingestion server 401 and an audio stream from an audio buffer 203 is sent to audio processor 405. Audio processor 405 sends the audio stream to app 406, which converts the speech to text. The parsed text is returned to audio processor 405, which returns the parsed text to ingestion server 401 (e.g., a user speech request for transportation). The processed text is sent to third party processor 402. Third party processor 402 sends the user location and a token to a third party application 407 (e.g., Uber® or Lyft™® application). In an embodiment, the token is an API and authorization token used to broker a request on behalf of the user. Application 407 returns a response data structure to third party processor 402, which is forwarded to ingestion server 401. Ingestion server 401 checks the ride arrival status (e.g., ETA) in the response data structure and sets up a callback to the user in user callback queue 408. Ingestion server 401 returns a response with a vehicle description to recorder 404, which can be spoken to the user by a digital assistant through a loudspeaker on the wearable multimedia device, or through the user's headphones or earbuds via a wired or wireless connection.

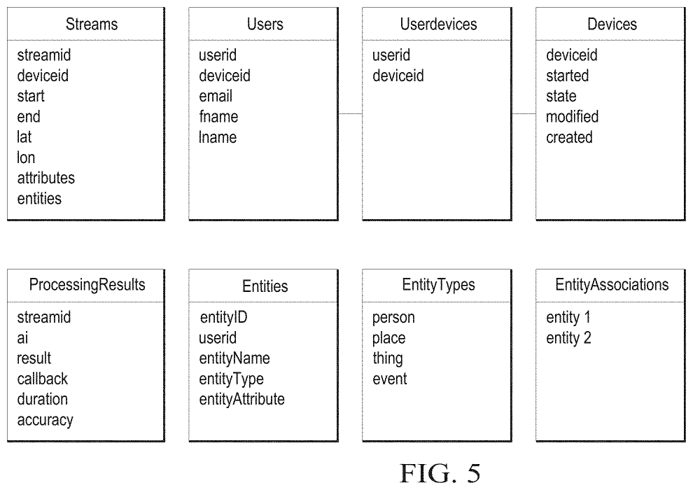

FIG. 5 illustrates data objects used by the data processing system of FIG. 2, according to an embodiment. The data objects are part of software component infrastructure instantiated on the cloud computing platform. A “streams” object includes the data streamid, deviceid, start, end, lat, lon, attributes and entities. “Streamid” identifies the stream (e.g., video, audio, photo), “deviceid” identifies the wearable multimedia device (e.g., a mobile device ID), “start” is the start time of the context data stream, “end” is the end time of the context data stream, “lat” is the latitude of the wearable multimedia device, “lon” is the longitude of the wearable multimedia device, “attributes” include, for example, birthday, facial points, skin tone, audio characteristics, address, phone number, etc., and “entities” make up an ontology. For example, the name “John Do” would be mapped to “Dad” or “Brother” depending on the user.

A “Users” object includes the data userid, deviceid, email, fname and lname. Userid identifies the user with a unique identifier, deviceid identifies the wearable device with a unique identifier, email is the user's registered email address, fname is the user's first name and lname is the user's last name. A “Userdevices” object includes the data userid and deviceid. A “devices” object includes the data deviceid, started, state, modified and created. In an embodiment, deviceid is a unique identifier for the device (e.g., distinct from a MAC address). Started is when the device was first started. State is on/off/sleep. Modified is the last modified date, which reflects the last state change or operating system (OS) change. Created is the first time the device was turned on.

A “ProcessingResults” object includes the data streamid, ai, result, callback, duration an accuracy. In an embodiment, streamid is each user stream as a Universally Unique Identifier (UUID). For example, a stream that was started from 8:00 AM to 10:00 AM will have id:15h158dhb4 and a stream that starts from 10:15 AM to 10:18 AM will have a UUID that was contacted for this stream. AI is the identifier for the platform application that was contacted for this stream. Result is the data sent from the platform application. Callback is the callback that was used (versions can change hence the callback is tracked in case the platform needs to replay the request). Accuracy is the score for how accurate the result set is. In an embodiment, processing results can be used for multiple tasks, such as 1) to inform the merge server of the full set of results, 2) determine the fastest AI so that user experience can be enhanced, and 3) determine the most accurate ai. Depending on the use case, one may favor speed over accuracy or vice versa.

An “Entities” object includes the data entityID, userID, entityName, entityType and entityAttribute. EntityID is a UUID for the entity and an entity having multiple entries where the entityID references the one entity. For example, “Barack Obama” would have an entityID of 144, which could be linked in an associations table to POTUS44 or “Barack Hussein Obama” or “President Obama.” UserID identifies the user that the entity record was made for. EntityName is the name that the userID would call the entity. For example, Malia Obama's entityName for entityID 144 could be “Dad” or “Daddy.” EntityType is a person, place or thing. EntityAttribute is an array of attributes about the entity that are specific to the userID's understanding of that entity. This maps entities together so that when, for example, Malia makes the speech query: “Can you see Dad?”, the cloud computing platform can translate the query to Barack Hussein Obama and use that in brokering requests to third parties or looking up information in the system.

### Example Processes

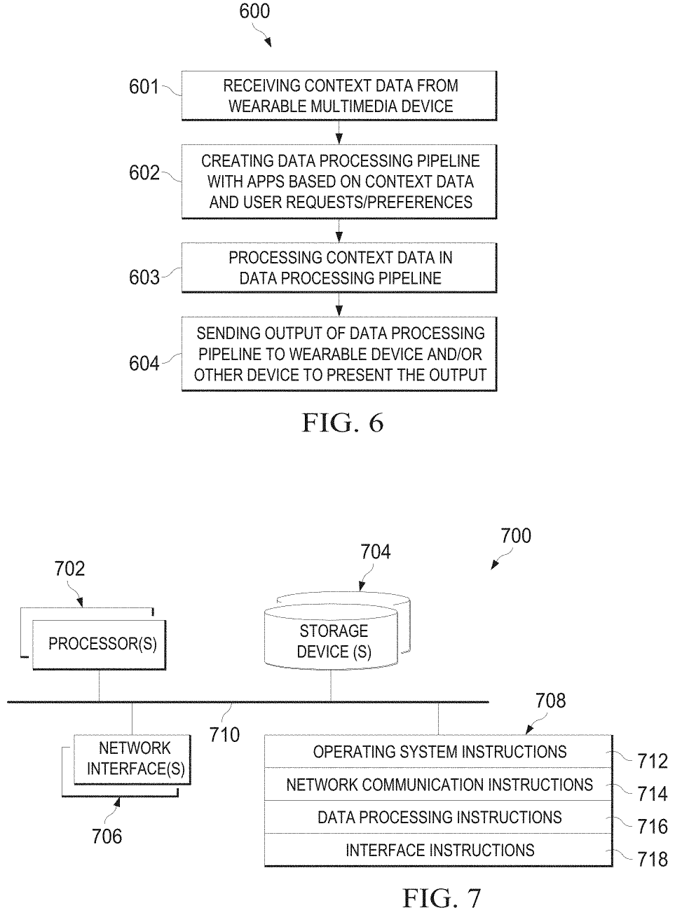

FIG. 6 is flow diagram of a data pipeline process, according to an embodiment. Process 600 can be implemented using wearable multimedia devices 101 and cloud computing platform 102 described in reference to FIGS. 1-5.

Process 600 can begin by receiving context data from a wearable multimedia device (601). For example, the context data can include video, audio and still images captured by a camera and audio subsystem of the wearable multimedia device.

Process 600 can continue by creating (e.g., instantiating) a data processing pipeline with applications based on the context data and user requests/preferences (602). For example, based on user requests or preferences, and also based on the data type (e.g., audio, video, photo), one or more applications can be logically connected to form a data processing pipeline to process the context data into a presentation to be playback on the wearable multimedia device or another device.

Process 600 can continue by processing the context data in the data processing pipeline (603). For example, speech from user commentary during a moment or transaction can be converted into text, which is then used to label objects in a video clip.

Process 600 can continue by sending the output of the data processing pipeline to the wearable multimedia device and/or other playback device (604).

### Example Cloud Computing Platform Architecture

FIG. 7 is an example architecture 700 for cloud computing platform 102 described in reference to FIGS. 1-6, according to an embodiment. Other architectures are possible, including architectures with more or fewer components. In some implementations, architecture 700 includes one or more processor(s) 702 (e.g., dual-core Intel® Xeon® Processors), one or more network interface(s) 706, one or more storage device(s) 704 (e.g., hard disk, optical disk, flash memory) and one or more computer-readable medium(s) 708 (e.g., hard disk, optical disk, flash memory, etc.). These components can exchange communications and data over one or more communication channel(s) 710 (e.g., buses), which can utilize various hardware and software for facilitating the transfer of data and control signals between components.

The term “computer-readable medium” refers to any medium that participates in providing instructions to processor(s) 702 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium(s) 708 can further include operating system 712 (e.g., Mac OS® server, Windows® NT server, Linux Server), network communication module 714, interface instructions 716 and data processing instructions 718.

Operating system 712 can be multi-user, multiprocessing, multitasking, multithreading, real time, etc. Operating system 712 performs basic tasks, including but not limited to: recognizing input from and providing output to devices 702, 704, 706 and 708; keeping track and managing files and directories on computer-readable medium(s) 708 (e.g., memory or a storage device); controlling peripheral devices; and managing traffic on the one or more communication channel(s) 710. Network communications module 714 includes various components for establishing and maintaining network connections (e.g., software for implementing communication protocols, such as TCP/IP, HTTP, etc.) and for creating a distributed streaming platform using, for example, Apache Kafka™. Data processing instructions 716 include server-side or backend software for implementing the server-side operations, as described in reference to FIGS. 1-6. Interface instructions 718 includes software for implementing a web server and/or portal for sending and receiving data to and from wearable multimedia devices 101, third party application developers 104 and third party platforms 105, as described in reference to FIG. 1.

Architecture 700 can be included in any computer device, including one or more server computers in a local or distributed network each having one or more processing cores. Architecture 700 can be implemented in a parallel processing or peer-to-peer infrastructure or on a single device with one or more processors. Software can include multiple software components or can be a single body of code.

### Example Wearable Multimedia Device Architecture

FIG. 8 is a block diagram of example architecture 800 for a wearable multimedia device implementing the features and processes described in reference to FIGS. 1-6. Architecture 800 may include memory interface 802, data processor(s), image processor(s) or central processing unit(s) 804, and peripherals interface 806. Memory interface 802, processor(s) 804 or peripherals interface 806 may be separate components or may be integrated in one or more integrated circuits. One or more communication buses or signal lines may couple the various components.

Sensors, devices, and subsystems may be coupled to peripherals interface 806 to facilitate multiple functions. For example, motion sensor(s) 810, biometric sensor(s) 812, and depth sensor(s) 814 may be coupled to peripherals interface 806 to facilitate motion, orientation, biometric, and depth detection functions. In some implementations, motion sensor(s) 810 (e.g., an accelerometer, rate gyroscope) may be utilized to detect movement and orientation of the wearable multimedia device.

Other sensors may also be connected to peripherals interface 806, such as environmental sensor(s) (e.g., temperature sensor, barometer, ambient light) to facilitate environment sensing functions. For example, a biometric sensor can detect fingerprints, face recognition, heart rate and other fitness parameters. In an embodiment, a haptic motor (not shown) can be coupled to the peripheral interface, which can provide vibration patterns as haptic feedback to the user.

Location processor 815 (e.g., GNSS receiver chip) may be connected to peripherals interface 806 to provide geo-referencing. Electronic magnetometer 816 (e.g., an integrated circuit chip) may also be connected to peripherals interface 806 to provide data that may be used to determine the direction of magnetic North. Thus, electronic magnetometer 816 may be used by an electronic compass application.

Camera subsystem 820 and an optical sensor 822, e.g., a charged coupled device (CCD) or a complementary metal-oxide semiconductor (CMOS) optical sensor, may be utilized to facilitate camera functions, such as recording photographs and video clips. In an embodiment, the camera has a 180° FOV and OIS. The depth sensor can include an infrared emitter that projects dots in a known pattern onto an object/subject. The dots are then photographed by a dedicated infrared camera and analyzed to determine depth data. In an embodiment, a time-of-flight (TOF) camera can be used to resolve distance based on the known speed of light and measuring the time-of-flight of a light signal between the camera and an object/subject for each point of the image.

Communication functions may be facilitated through one or more communication subsystems 824. Communication subsystem(s) 824 may include one or more wireless communication subsystems. Wireless communication subsystems 824 may include radio frequency receivers and transmitters and/or optical (e.g., infrared) receivers and transmitters. Wired communication systems may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data (e.g., a projector).

The specific design and implementation of the communication subsystem 824 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, IEEE802.xx communication networks (e.g., Wi-Fi, WiMax, ZigBee™), 3G, 4G, 4G LTE, code division multiple access (CDMA) networks, near field communication (NFC), Wi-Fi Direct and a Bluetooth™ network. Wireless communication subsystems 824 may include hosting protocols such that the device may be configured as a base station for other wireless devices. As another example, the communication subsystems may allow the device to synchronize with a host device using one or more protocols or communication technologies, such as, for example, TCP/IP protocol, HTTP protocol, UDP protocol, ICMP protocol, POP protocol, FTP protocol, IMAP protocol, DCOM protocol, DDE protocol, SOAP protocol, HTTP Live Streaming, MPEG Dash and any other known communication protocol or technology.

Audio subsystem 826 may be coupled to a speaker 828 and one or more microphones 830 to facilitate voice-enabled functions, such as voice recognition, voice replication, digital recording, telephony functions and beamforming.

I/O subsystem 840 may include touch controller 842 and/or another input controller(s) 844. Touch controller 842 may be coupled to a touch surface 846. Touch surface 846 and touch controller 842 may, for example, detect contact and movement or break thereof using any of a number of touch sensitivity technologies, including but not limited to, capacitive, resistive, infrared, and surface acoustic wave technologies, as well as other proximity sensor arrays or other elements for determining one or more points of contact with touch surface 846. In one implementation, touch surface 846 may display virtual or soft buttons, which may be used as an input/output device by the user.

Other input controller(s) 844 may be coupled to other input/control devices 848, such as one or more buttons, rocker switches, thumb-wheel, infrared port, USB port, and/or a pointer device such as a stylus. The one or more buttons (not shown) may include an up/down button for volume control of speaker 828 and/or microphone 830.

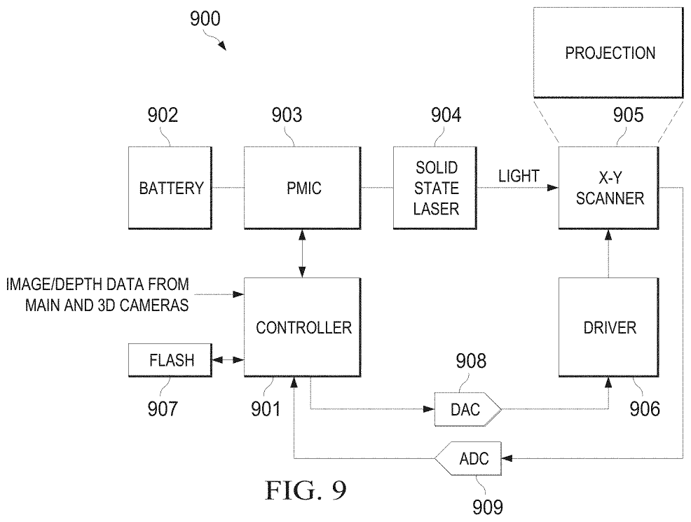

Further, a projector subsystem 832 may be connected to peripherals interface 806 to present information visually to a user in the form of projected light. For example, the projector subsystem 832 can project light onto a surface according to a particular spatial and/or temporal pattern, such that the user perceives text, images, videos, colors, patterns, and/or any other graphical information on the surface. In some implementations, the projector subsystem 832 can project light onto a surface of the user's body, such as the user's hand or palm. In some implementations, the projector subsystem 832 can project light onto a surface other than the user's body, such as a wall, a table, a desk, or any other object. The projector subsystem 832 is described in greater detail with reference to FIG. 9.

In some implementations, the projector subsystem 832 project light onto a surface to provide an interactive VI for a user. For example, the projector subsystem 832 can project light onto the surface, such that the user perceives one or more interactive user interface elements (e.g., selectable buttons, dials, switches, boxes, images, videos, text, icons, etc.). Further, the user can interact with the VI by performing one or more gestures with respect to the VI and the user interface elements. For example, the user can perform a pointing gesture, a tapping gesture, a swiping gesture, a waving gesture, or any other gesture using her hands and/or fingers. The wearable multimedia device can detect the performed gestures using one or more sensors (e.g., the camera/video subsystems 820, environment sensor(s) 817, depth sensor(s) 814, etc.), identify one or more commands associated with those gestures, and execute the identified commands (e.g., using the processor(s) 804). Example VIs are described in further detail below.

In some implementations, device 800 plays back to a user recorded audio and/or video files (including spatial audio), such as MP3, AAC, spatial audio and MPEG video files. In some implementations, device 800 may include the functionality of an MP3 player and may include a pin connector or other port for tethering to other devices. Other input/output and control devices may be used. In an embodiment, device 800 may include an audio processing unit for streaming audio to an accessory device over a direct or indirect communication link.

Memory interface 802 may be coupled to memory 850. Memory 850 may include high-speed random access memory or non-volatile memory, such as one or more magnetic disk storage devices, one or more optical storage devices, or flash memory (e.g., NAND, NOR). Memory 850 may store operating system 852, such as Darwin, RTXC, LINUX, UNIX, OS X, iOS, WINDOWS, or an embedded operating system such as VxWorks. Operating system 852 may include instructions for handling basic system services and for performing hardware dependent tasks. In some implementations, operating system 852 may include a kernel (e.g., UNIX kernel).

Memory 850 may also store communication instructions 854 to facilitate communicating with one or more additional devices, one or more computers or servers, including peer-to-peer communications with wireless accessory devices, as described in reference to FIGS. 1-6. Communication instructions 854 may also be used to select an operational mode or communication medium for use by the device, based on a geographic location of the device.

Memory 850 may include sensor processing instructions 858 to facilitate sensor-related processing and functions and recorder instructions 860 to facilitate recording functions, as described in reference to FIGS. 1-6. Other instructions can include GNSS/Navigation instructions to facilitate GNSS and navigation-related processes, camera instructions to facilitate camera-related processes and user interface instructions to facilitate user interface processing, including a touch model for interpreting touch inputs.

Each of the above identified instructions and applications may correspond to a set of instructions for performing one or more functions described above. These instructions need not be implemented as separate software programs, procedures, or modules. Memory 850 may include additional instructions or fewer instructions. Furthermore, various functions of the device may be implemented in hardware and/or in software, including in one or more signal processing and/or application specific integrated circuits (ASICs).

FIG. 9 is a system block diagram of the projector subsystem 832, according to an embodiment. The projector subsystem 832 scans a pixel in two dimensions, images a 2D array of pixels, or mixes imaging and scanning. Scanning projectors directly utilize the narrow divergence of laser beams, and two-dimensional (2D) scanning to “paint” an image pixel by pixel. In some embodiments, separate scanners are used for the horizontal and vertical scanning directions. In other embodiments, a single biaxial scanner is used. The specific beam trajectory also varies depending on the type of scanner used.

In the example shown, the projector subsystem 832 is a scanning pico-projector that includes controller 901, battery 902, power management chip (PMIC) 903, solid state laser 904, X-Y scanner 905, driver 906, memory 907, digital-to-analog converter (DAC) 908 and analog-to-digital converter (ADC) 909.

Controller 901 provides control signals to X-Y scanner 905. X-Y scanner 905 uses moveable mirrors to steer the laser beam generated by solid state laser 904 in two dimensions in response to the control signals. X-Y scanner 905 includes one or more micro-electromechanical (MEMS) micromirrors that have controllable tilt angles in one or two dimensions. Driver 906 includes a power amplifier and other electronic circuitry (e.g., filters, switches) to provide the control signals (e.g., voltages or currents) to X-Y scanner 905. Memory 907 stores various data used by the projector including laser patterns for text and images to be projected. DAC 908 and ADC 909 provide data conversion between digital and analog domains. PMIC 903 manages the power and duty cycle of solid state laser 1904, including turning on and shutting of solid state laser 904 and adjusting the amount of power supplied to solid state laser 904. Solid state laser 904 can be, for example, a vertical-cavity surface-emitting laser (VCSEL).

In an embodiment, controller 901 uses image data from the camera/video subsystem 820 and/or depth data from the depth sensor(s) 814 to recognize and track user hand and/or finger positions on the laser projection, such that user input is received by the wearable multimedia device 101 using the laser projection as an input interface.

In another embodiment, the projector subsystem 832 uses a vector-graphic projection display and low-powered fixed MEMS micromirrors to conserve power. Because the projector subsystem 832 includes a depth sensor, the projected area can be masked when necessary to prevent projecting on a finger/hand interacting with the laser projected image. In an embodiment, the depth sensor can also track gestures to control the input on another devices (e.g., swiping through images on a TV screen, interacting with computers, smart speakers, etc.).

In other embodiments, Liquid Crystal on Silicon (LCoS or LCOS), Digital Light Processing (DLP) or Liquid Chrystal Display (LCD) digital projection technology can be used instead of a pico-projector.

### Gesture Recognition

In an embodiment, a gesture recognition process begins by receiving a depth image frame from a depth sensor, and projecting each pixel in the depth image into 3D space using camera intrinsic parameters to generate a point cloud of 3D data points (e.g., x, y, z coordinates). In an embodiment, the depth sensor is a TOF sensor.

The process continues by reducing the point cloud to make the 3D data points more spatially uniform by, for example, using a voxel grid filter to down sample the 3D data points. The voxel grid filter computes a spatial average of the 3D data points confined by each voxel. The set of 3D data points which lie within the bounds of a voxel are assigned to that voxel and are statistically combined into one output 3D data point. In an embodiment, a voxel is 8×8×8 millimeters.

The process continues by dividing the 3D points into clusters. In an embodiment, a Euclidian cluster extraction algorithm is used to divide the 3D points into clusters. For example, if the Euclidean distance between two 3D points is less than x mm (e.g., 15 mm) apart, they belong to the same cluster. This typically yields about 10-20 remaining clusters. In an embodiment, other region-based, edge-based or model-based clustering can be used, such as RANSAC, density-based spatial clustering of applications with noise (DBSCAN) and k-means.

The process continues by deleting clusters with too few points (e.g., less than 200 points. The deleting of clusters with too few points removes noise and outliers, and typically results in 0 to 2 clusters. If there are no clusters remaining the process assumes that there is no hand in the frame. If there is one cluster remaining the process presumes there is one hand in the frame. If there are two clusters remaining the process assumes that there are two hands in the frame.

The process continues by identifying for each hand cluster if it is a left or right hand by checking from which side the arm points enter the frame. In an embodiment, this is done by counting the number of points in the left and right third of the frame, and whichever of the left or right-third has more points determines if the hand cluster is a left or right hand.

The process continues by removing the arm points from the hand cluster. In an embodiment, this is accomplished by starting from the furthest point from the camera, and adding up the visible surface area until a specified surface area dimension is reached (e.g., 140 cm²).

The process continues by determining a dominant axis of the hand cluster that represents the hand direction . In an embodiment, the dominant axis of the hand cluster is determined by computing a least squares fit of a line to the points in the hand cluster.

The process continues by isolating a pointing finger cluster (e.g., the index finger) if the user is pointing. In an embodiment, the furthest point away from the depth sensor in the hand direction is determined, and the all 3D data points within a specified distance (e.g., 75 mm) of that furthest point is included in the finger cluster.

The process continues by determining a dominant axis of the finger cluster to find the finger pointing direction. In an embodiment, the dominant axis of the finger cluster is determined by computing a least squares fit of a line to the points in the finger cluster.

The process continues by generating a bounding box for the hand cluster that also includes any object the hand may be holding (the hand and held object are a single cluster in 3D space), and then projecting the bounding box into 2D space using camera intrinsic parameters computed from viewing a test pattern with a 2D camera and 3D depth sensor at the same time.

The process continues by generating a list of candidate held objects by intersecting the resulting 2D bounding box with the 2D bounding boxes of recognized objects in the 2D camera and 3D depth images. For each candidate held object, a center point of the 2D bounding box and a distance (e.g., z distance or depth) from the center point to the hand is determined, and the closest candidate held object is selected as the held object based on the distances.

In an alternative embodiment, hand/finger poses can be identified in the point clusters by analyzing the distribution of points in the clusters using principal component analysis (PCA), where the principal components are eigenvectors, the first eigenvector represents the direction of most variance in the points, the first and second eigenvector define a regression plane in the 3D space and the third eigenvector represents the surface normal to the regression plane. In an embodiment, the first eigenvector can be used to estimate the finger pointing direction.

In an alternative embodiment, a hand/finger pose can be estimated by matching the point cloud to previously generated point clouds of 3D hand/finger models stored in a database. In an embodiment, known 3D object detection deep learning networks, such as PointRNN or VoxelNet can be used to detect and label 3D hands/fingers in the point cloud either on the device or on a network-based server computer.

### Fingernail Projections

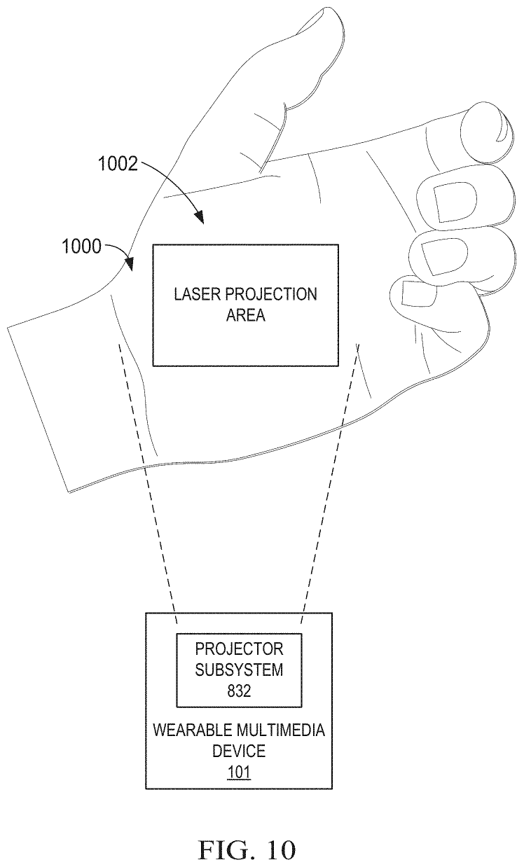

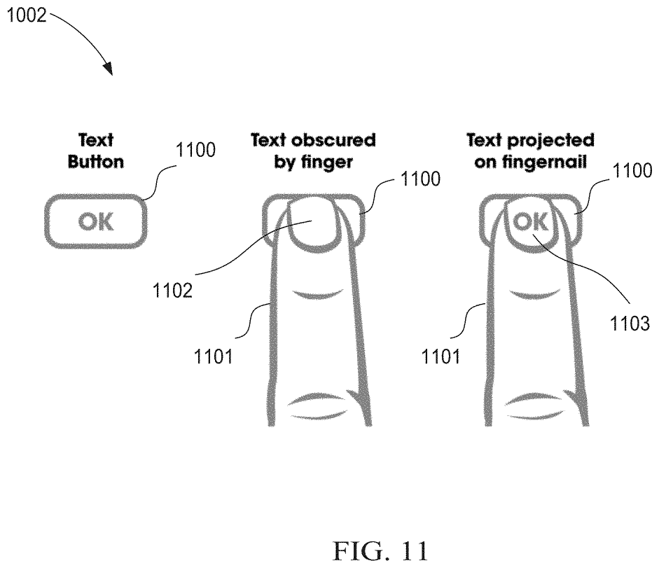

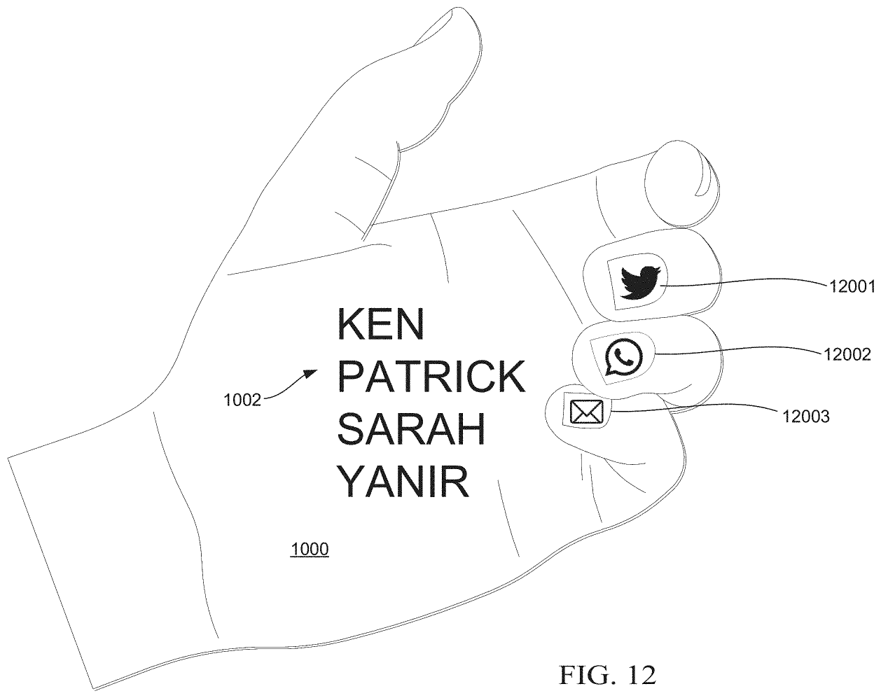

FIG. 10 illustrates a laser projection area 1002 on a user's palm 1000, according to an embodiment. Laser project area 1002 can be generated using, for example, the laser projection subsystem 832 of wearable device 101, as described in reference to FIG. 9. In an embodiment, laser projection subsystem 832 projects one or more user interface elements into laser projection area 1002 of the user's palm 1000. In the case that the one or more user interface elements respond to user input, there is a possibility that the one or more user interface elements will become obscured by the user's finger or another object. In such a scenario, laser projection subsystem 832 can move the projection of the obscure user interface element to one of the user's fingernails, as described in reference to FIG. 11.

FIG. 11 illustrates moving a projection of user interface element 1100 on a surface (e.g., palm 1000) to the user' fingernail 1102, according to an embodiment. In this example scenario, a text “OK” button is originally projected on palm 1000. In other scenarios, the text button 1100 can be originally projected on any surface, such as a table top, whiteboard, etc. When the user attempts to select the text button 1100 (e.g., by hovering over the text button 1100), laser projection subsystem 832 moves or reprojects the text button 1103 onto fingernail 1102, such that the text is no longer obscured. In an embodiment, a gesture recognition process (e.g., as described above) is used to locate finger nail 1102 in a camera image and/or depth data. For example, the camera can receive reflected laser light from the surface and use the reflected light to determine a location of the text button 1100 in two-dimensional (2D) camera coordinates based on known laser projection registration techniques. The depth sensor and/or camera can be used to determine the location of the user's finger and fingernail 1102 and project the depth data into the 2D camera coordinates using camera intrinsic parameters (e.g., pinhole projection) known in the art. If there is specified overlap of the finger and text button 1100 (e.g., determine a percentage of overlap), the text button 1100 will be determined to be obscured.

When the text button 1100 is deemed to be obscured, laser projection subsystem 832 moves/reprojects text button 1100 at the determined location of fingernail 1102. Additionally, the surface area of fingernail 1102 is determined based on camera and/or depth data and used to change the size of the text button 1100 so that it fits on the nail plate of fingernail 1102. In an embodiment, the resolutions of the text button 1100 is also adjusted. In an embodiment, fingernail 1102 is tracked by laser projection subsystem 832 to ensure that text button 1100 remains on fingernail 1102 if the user should move their finger within the FOV of the camera/depth sensor. In an embodiment, multiple user interface elements can be moved to multiple fingernails. If the fingernail surface becomes undetectable, any other detected fingernail or other surface can be used for the projection of text button 1100. For example, if the user is holding or is proximate to an object (e.g., a cup, a ring on the finger) in the sensor FOV, laser projection subsystem 832 can move one or more obscured user interface elements to one or more surfaces of the object so they can be seen and/or read by the user.

FIG. 12 illustrates projecting user interface elements on a user's fingernails 12001-12003 to augment another user interface element 1202 projected on the user's palm or other surface, according to an embodiment.

In the example scenario shown, user interface element 1202 (e.g., a contact list) is projected on user's palm 1200. Additional user interface elements (e.g., Icons) related to user interface element 1202 are projected onto fingernails 1201-1203. In this example, a contact list is projected on palm 1200 that includes Richard, PingPing, Yunbo and Ayan. Icons representing various modes of communication with these contacts (e.g., email, VoIP, Twitter®) are projected onto fingernails 12001-12003. In an embodiment, the user can invoke an action represented by the icon making a gesture with the finger with the projection. For example, if the user wants to send an email to Richard, she can point her right hand index finger at Richard, and bend or flick her pinky finger to indicate a preference for email. The embodiment shown in FIG. 12 can be extended to both the left and right hand of the user, and the icons can be any desired user interface element (e.g., icons, text, numbers, letters, keys, buttons). If fingernails are not detected in the sensor FOV, then the user interface elements can be projected on to one or more surfaces of one or more objects in the sensor FOV.

### Example Processes

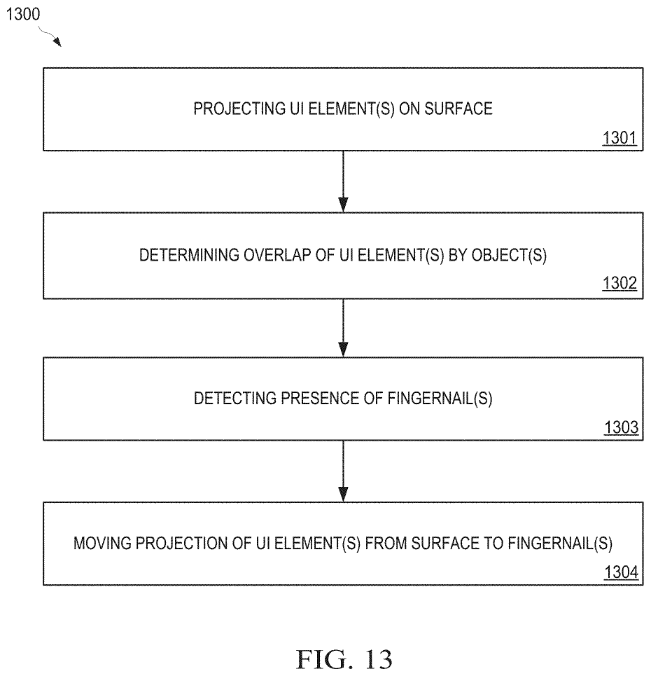

FIG. 13 is a flow diagram of a process 1300 of moving a projection of a user interface element on a user's palm or other surface to the user' fingernail or other surface, according to an embodiment. Process 1300 can be implemented using wearable multimedia devices 101 described in reference to FIGS. 1-12.

Process 1300 includes the steps of: projecting, with a laser projector of a wearable multimedia device, a user interface element onto a surface (1301); determining, based on sensor data obtained from at least one sensor of the wearable multimedia device, that the user interface element is at least partially obscured by an object (1302); detecting, based on the sensor data, a fingernail of a user of the wearable multimedia device (1303); and responsive to the detecting that the user interface element is at least partially obscured by the object, and detecting the fingernail of the user of the wearable multimedia device, projecting the user interface element on the fingernail (1304). Each of the foregoing steps was previously described in reference to FIGS. 11 and 12. The order of the foregoing steps are exemplary and one or more steps can be performed in parallel and/or in a different order then presented above. The first and/or second set of UI elements can include one or more UI elements.

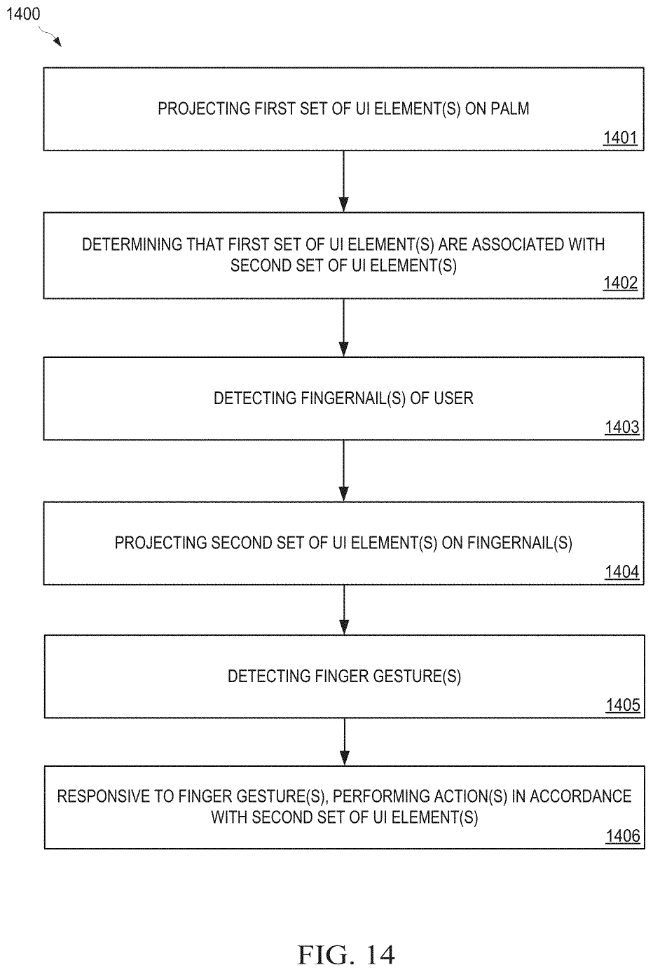

FIG. 14 is a flow diagram of a process for projecting user interface elements on a user's fingernails to augment a user interface element projected on the user's palm, according to an embodiment. Process 1400 can be implemented using wearable multimedia devices 101 described in reference to FIGS. 11-12. The order of the foregoing steps are exemplary and one or more steps can be performed in parallel and/or in a different order then presented above.

Process 1400 can include the steps of: projecting, with a laser projector of a wearable multimedia device, a first set of user interface element(s) onto a surface (1401); determining, based on sensor data obtained from at least one sensor of the wearable multimedia device, that the first set of user interface elements is associated with a second set of user interface elements (1402); detecting, based on the sensor data, one or more fingernails of a user of the wearable multimedia device (1403); and responsive to determining that the first set of user interface elements is associated with the second set of user interface elements, and detection of one or more fingernails of the user of the wearable multimedia device, projecting the second set of user interface elements on the one or more fingernails (1404). Each of the foregoing steps were previously described in reference to FIGS. 11-12. The order of the foregoing steps are exemplary and one or more steps can be performed in parallel and/or in a different order then presented above. The first and/or second set of UI elements can include one or more UI elements.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor. Method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
projecting, with a laser projector of a wearable multimedia device, a user interface element onto a surface;
determining, based on sensor data obtained from at least one sensor of the wearable multimedia device, that the user interface element is at least partially obscured by an object;
detecting, based on the sensor data, a fingernail of a user of the wearable multimedia device;
responsive to determining that the user interface element is at least partially obscured by the object, and detecting the fingernail of the user of the wearable multimedia device, changing the size and resolution of the user interface element so that it fits on the fingernail of the user; and projecting the user interface element on the fingernail.

2. The method of claim 1, wherein the surface is the user's palm.

3. The method of claim 1, wherein the sensor data includes depth data captured by at least one of a camera or a depth sensor.

4. The method of claim 1, further comprising:
detecting, based on the sensor data, a gesture made by a finger that includes the fingernail; and
responsive to the gesture, performing at least one action on the wearable multimedia device.

5. The method of claim 1, wherein the user interface element is an icon.

6. The method of claim 1, wherein detecting that the user interface element is at least partially obscured by an object, further comprises:
determining a percentage of overlap of the user interface element by the object.

7. The method of claim 1, wherein determining, based on sensor data obtained from at least one sensor of the wearable multimedia device, that the user interface element is at least partially obscured by an object, further comprises:
detecting, based on camera data in a camera reference frame, a user interface element location on the surface;
detecting, based on depth data, an object location;
projecting at least a portion of the depth data representing the object into a camera reference frame; and
determining, based on the locations of the user interface element and the object in the camera reference frame, that the user interface element is at least partially obscured by the object.

8. A method comprising:
projecting, with a laser projector of a wearable multimedia device, a user interface element onto a surface;
determining, based on sensor data obtained from at least one sensor of the wearable multimedia device, that the user interface element is associated with one or more other user interface elements;
detecting, based on the sensor data, one or more fingernails of a user of the wearable multimedia device; and
responsive to determining that the user interface element is associated with one or more other user interface elements, and detecting one or more fingernails of the user of the wearable multimedia device, changing the size and resolution of the user interface element so that it fits on the fingernail of the user; and projecting the one or more other user interface elements on the one or more fingernails.

9. The method of claim 8, wherein the surface is the user's palm.

10. The method of claim 8, wherein the sensor data includes depth data captured by at least one of a camera or a depth sensor.

11. The method of claim 8, further comprising:
detecting, based on the sensor data, a gesture made by a finger that includes one of the fingernails; and
responsive to the gesture, performing at least one action on the wearable multimedia device.

12. The method of claim 8, wherein the user interface element is an icon.

13. The method of claim 8, wherein determining that the user interface element is at least partially obscured by an object, further comprises:
determining a percentage of overlap of the user interface element by the object.

14. The method of claim 8, further comprises:
determining, based on at least one of camera data or depth data, one or more fingernail locations; and
projecting, based on the one or more fingernail locations, the one or more other user interface elements at the one or more fingernail locations.

15. A system comprising:
at least one processor; and
memory storing instructions that, when executed by the at least one processor, cause the at least one processor to perform operations comprising:
projecting, with a laser projector of a wearable multimedia device, a user interface element onto a surface;
determining, based on sensor data obtained from at least one sensor of the wearable multimedia device, that the user interface element is at least partially obscured by an object;
determining, based on the sensor data, a fingernail of a user of the wearable multimedia device; and
responsive to the determining that the user interface element is at least partially obscured by the object, and detecting the fingernail of the user of the wearable multimedia device, changing the size and resolution of the user interface element so that it fits on the fingernail of the user; and projecting the user interface element on the fingernail.

16. The system of claim 15, wherein the surface is the user's palm.

17. The system of claim 15, wherein the sensor data includes depth data captured by at least one of a camera or a depth sensor.

18. The system of claim 15, further comprising:
detecting, based on the sensor data, a gesture made by a finger that includes the fingernail; and
responsive to the gesture, performing at least one action on the wearable multimedia device.

19. The system of claim 15, wherein the user interface element is an icon.

20. The system of claim 15, wherein determining that the user interface element is at least partially obscured by an object, further comprises:
determining a percentage of overlap of the user interface element by the object.

21. The system of claim 15, wherein determining, based on sensor data obtained from at least one sensor of the wearable multimedia device, that the user interface element is at least partially obscured by an object, further comprises:
determining, based on camera data in a camera reference frame, a user interface element location on the surface;
determining, based on depth data, an object location;
projecting at least a portion of the depth data representing the object into a camera reference frame; and
determining, based on the locations of the user interface element and the object in the camera reference frame, that the user interface element is at least partially obscured by the object.

22. A system comprising:
at least one processor; and
memory storing instructions that, when executed by the at least one processor, cause the at least one processor to perform operations comprising:
projecting, with a laser projector of a wearable multimedia device, a user interface element onto a surface;
determining, based on sensor data obtained from at least one sensor of the wearable multimedia device, that the user interface element is associated with one or more other user interface elements;
determining, based on the sensor data, one or more fingernails of a user of the wearable multimedia device; and
responsive to determining that the user interface element is associated with one or more other user interface elements, and detecting one or more fingernails of the user of the wearable multimedia device, changing the size and resolution of the user interface element so that it fits on the fingernail of the user; and projecting the one or more other user interface elements on the one or more fingernails.

23. The system of claim 22, wherein the surface is the user's palm.

24. The system of claim 22, wherein the sensor data includes depth data captured by at least one of a camera or a depth sensor.

25. The system of claim 22, further comprising:
detecting, based on the sensor data, a gesture made by a finger that includes one of the fingernails; and
responsive to the gesture, performing at least one action on the wearable multimedia device.

26. The system of claim 22, wherein the user interface element is an icon.

27. The system of claim 22, wherein determining that the user interface element is at least partially obscured by the object, further comprises:
determining a percentage of overlap of the user interface element by the object.

28. The system of claim 22, further comprises:
determining, based on at least one of camera data or depth data, one or more fingernail locations; and
projecting, based on the one or more fingernail locations, the one or more other user interface elements at the one or more fingernail locations.
